(19) United States
(12) Patent Application Publication
(10) Pub. No.: US 2007/0238434 A1
(43) Pub. Date: Oct. 11, 2007

(54) Clock modulation circuits with time averaging

(76) Inventors: Nasser Kurd, Portland, OR (US); Javed Barkatullah, Portland, OR (US); Tim Frodsham, Portland, OR (US)

Correspondence Address: Lee & Hayes, PLLC;C/O Intellevate, P.O. Box 52050, Minneapolis, MN, 55402, US

(21) Appl. No.: 11/394,532

(22) Filed: Mar. 30, 2006

(51) Int. Cl. H04B 1/40; H04B 1/18; H04B 7/00

(52) U.S. Cl. 455/260; 455/76; 455/180.3

(57) ABSTRACT

Embodiments of clock modulation circuits with time averaging are described herein.

### BACKGROUND

Delay locked loops (DLL) and phase locked loops (PLL) are utilized to implement clock management in synchronous sequential circuits, high speed serial communications and the like. DLLs and PLLs provide for clock synthesis and low-clock skew distribution. With the increases in clock rates, the reduction of jitter in DLLs and PLLs is becoming increasingly important to achieve desired design performance objectives. Conventional methods of reducing jitter in DLLs and PLLs includes reducing power supply injected noise and/or utilizing differential delay elements to reject common mode noise. However, current and future circuits will benefit from further jitter control in DLLs and PLLs.

### BRIEF DESCRIPTION OF THE DRAWINGS

Embodiments are illustrated by way of example and not by way of limitation, in the figures of the accompanying drawings and in which like reference numerals refer to similar elements and in which:

FIG. 1 shows a block diagram of an exemplary environment which may provide and/or utilize a delay locked loop or phase locked loop;

FIG. 2 shows a block diagram of an exemplary embodiment of a clock modulation circuit with time averaging;

FIG. 3 shows a block diagram of another exemplary embodiment of a clock modulation circuit with time averaging;

FIG. 4 shows a block diagram of another exemplary embodiment of a clock modulation circuit with time averaging;

FIG. 5 shows a circuit diagram of an exemplary embodiment of a delay locked loop with time averaging;

FIG. 6 shows a circuit diagram of an exemplary embodiment of a time averaging circuit; and

FIG. 7 shows a flow diagram of an exemplary method of modulating a clock signal.

### DETAILED DESCRIPTION

In the following discussion, an exemplary environment is described which is operable to employ clock modulation circuits, such as a delay locked loop (DLL) or phase locked loop (PLL). Exemplary clock modulation circuits implementing time averaging are also described which may be employed in various types of devices. Exemplary time averaging methods are also described which may also be employed by clock modulation circuits in various types of devices.

Exemplary Environment

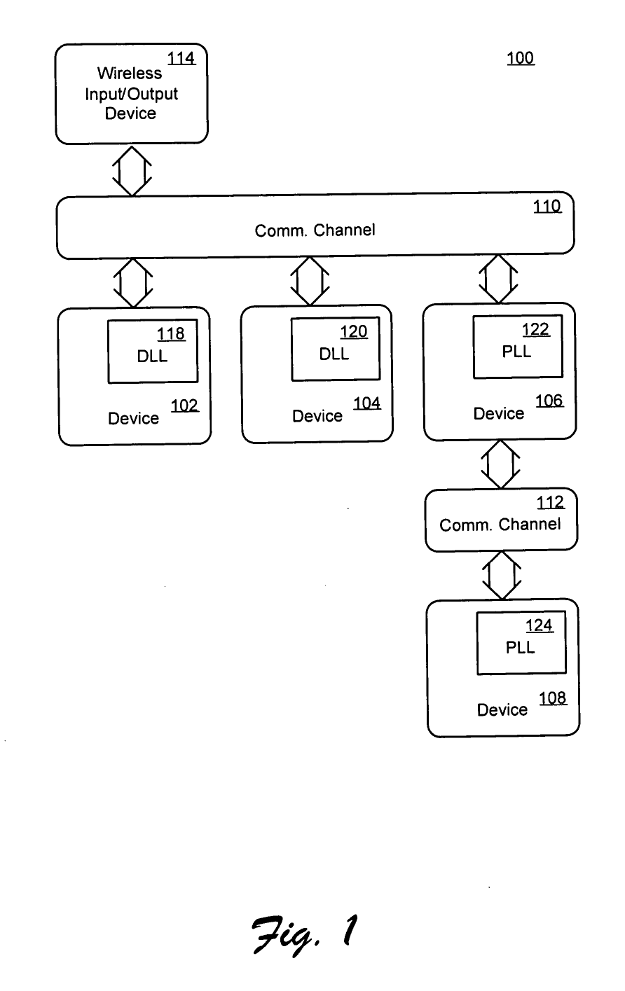

FIG. 1 shows a block diagram of an exemplary environment 100 which may provide and/or utilize clock modulation circuits, such as delay locked loops and/or phase locked loops. The exemplary environment 100 may include one or more devices 102-108 communicatively coupled by one or more communication channels 110, 112. The exemplary environment 100 may further include one or more wireless input/output devices 114 coupled to one or more devices 102-108 via the communication channel 110 to provide a wireless communication link.

Each communication channel 110, 112 may include data and clock lines. Each device 102-108 that is communicatively coupled to a communication channel 110, 112 may include a delay locked loop (DLL) 118, 120 or phase locked loop (PLL) 122, 124. The DLLs 118, 120 or PLLs 122, 124 in each device 102-108 may be utilized, for example, to recover a clock signal used to latch data. In another example, the DLLs 118, 120 or PLLs 122, 124 may be utilized to control operation of synchronous circuits in a given device. In yet another example, the DLLs 118, 120 or PLLs 122, 124 may be utilized in clock synthesis to generate clock signals with different frequencies, phase delays and/or duty cycles, and/or clock signals that can be synchronized to one or more other clock signals.

Exemplary Clock Modulation Circuit with Time Averaging

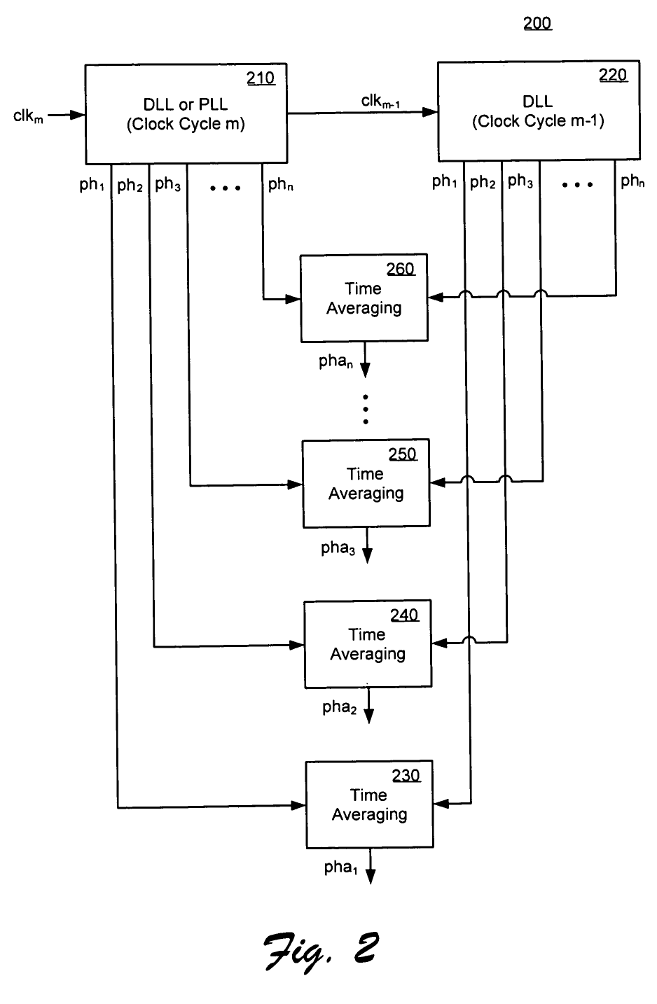

FIG. 2 shows an exemplary embodiment of a clock modulation circuit with time averaging 200. In one embodiment, the clock modulation circuit with time averaging 200 includes a first delay locked loop (DLL) 210, a second DLL 220 coupled in series with the first DLL 210, and a plurality of time averaging circuits 230-260 coupled between the first and second DLLs 210, 220. In another embodiment, the clock modulation circuit with time averaging 200 includes a first phase locked loop (PLL) 210, a first DLL 220 coupled in series with the first PLL 210, and a plurality of time averaging circuits 230-260 coupled between the first PLL 210 and the first DLL 220.

DLLs and PLLs both compare a reference clock and a feedback clock and adjust the performance of the circuit to align the phases of the reference and feedback clock signals. In DLLs, a delay line inserts a plurality of controlled phase delays. In PLLs, the delay line is used as a ring oscillator that is realized by feeding the output back to the input to form a feedback loop. Although in the following discussion, the time averaging function is further described with reference to DLLs to explain the operating principles it should be readily apparent that these techniques are equally applicable to PLLs.

The first DLL 210 receives an incoming clock signal (clkₘ) at its input and generates a plurality of phase shifted clock signals (ph₁, ph₂, ph₃, . . . phₙ) at its outputs. The second DLL 220 receives the differential clock signal (clkₘ₋₁) at its input, after propagation through the first DLL 210. The differential clock signal (clkₘ₋₁) received by the second DLL 220 is delayed one full clock cycle as compared to the clock signal (clkₘ) received by the first DLL 210. Thus, the plurality of phase shifted clock signals (ph₁, ph₂, ph₃, . . . phₙ) generated by the second DLL 220 are delayed one clock cycle with respect to the corresponding one of the plurality of phase shifted clock signals (ph₁, ph₂, ph₃, . . . phₙ) generated by the first DLL 210.

The corresponding phase shifted clock signals from each of the DLLs 210, 220 (e.g., from two adjacent clock cycles) are received by a corresponding one of the plurality of time averaging circuits 230-260. For example, the first phase shifted clock signal (ph₁) from each of the DLLs 210, 220 are received by the first time averaging circuit 230, while the nth phase shifted clock cycle (phₙ) from each of the DLLs 210, 220 are received by the nth time averaging circuit 260. The time averaging circuits 230-260 mix the phases of the corresponding phase shifted clock signals (ph₁, ph₂, ph₃, . . . phₙ) from the first and second DLLs 210, 220 to generate corresponding average phase shifted signals (pha₁, pha₂, pha₃, . . . phaₙ) at their respective outputs. Thus, the time averaging circuits 230-260 average the phase shift between corresponding phase shifted clock signals (ph₁, ph₂, ph3, . . . phₙ) of adjacent clock cycles (m, m-1). The averaging of corresponding phase shifted clock signals from adjacent clock cycles reduces jitter between the first and last phase shifted clock signals (ph₁, ph₂, ph₃, . . . phₙ), because the last phase shifted clock signal will be referenced from the previous cycle of the clk input.

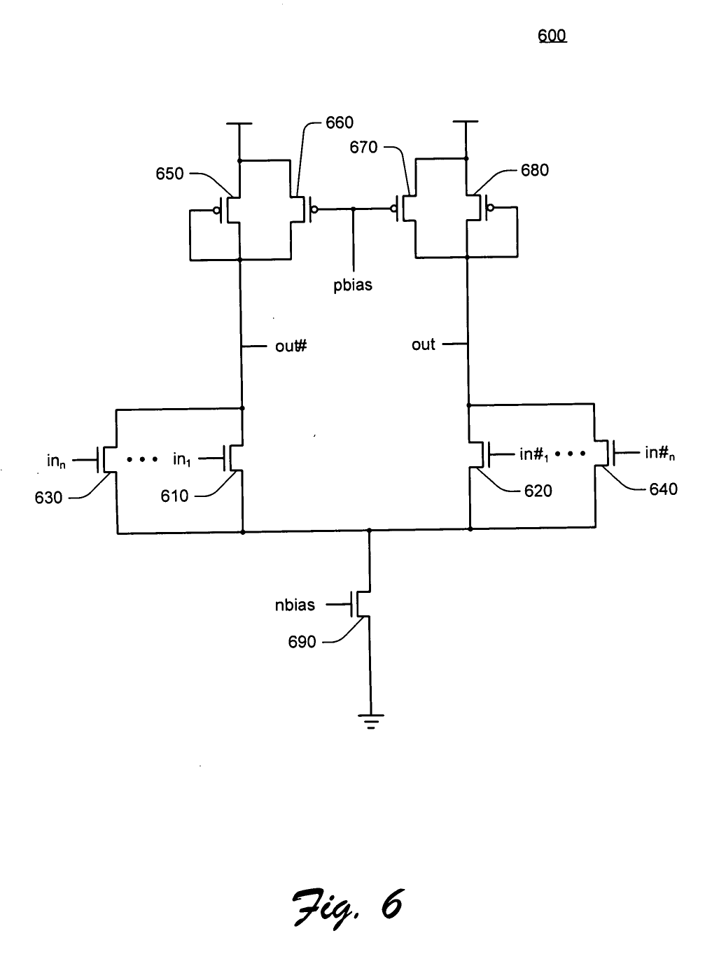

The exemplary embodiment of the DLL with time averaging 200, as described above and shown in FIG. 2, averages the plurality of phase shifted clock signals over two clock cycles. However, those skilled in the art will appreciate that the above described time averaging function may be adapted to average corresponding phase shifted clock signals over three or more clock cycles. Time averaging over additional clock cycles can be achieved by adding additional serially coupled DLLs and modifying the number of inputs averaged by the time averaging circuits. An exemplary time averaging circuit adaptable to receive and average any number of inputs is described in more detail below with regard to FIG. 6.

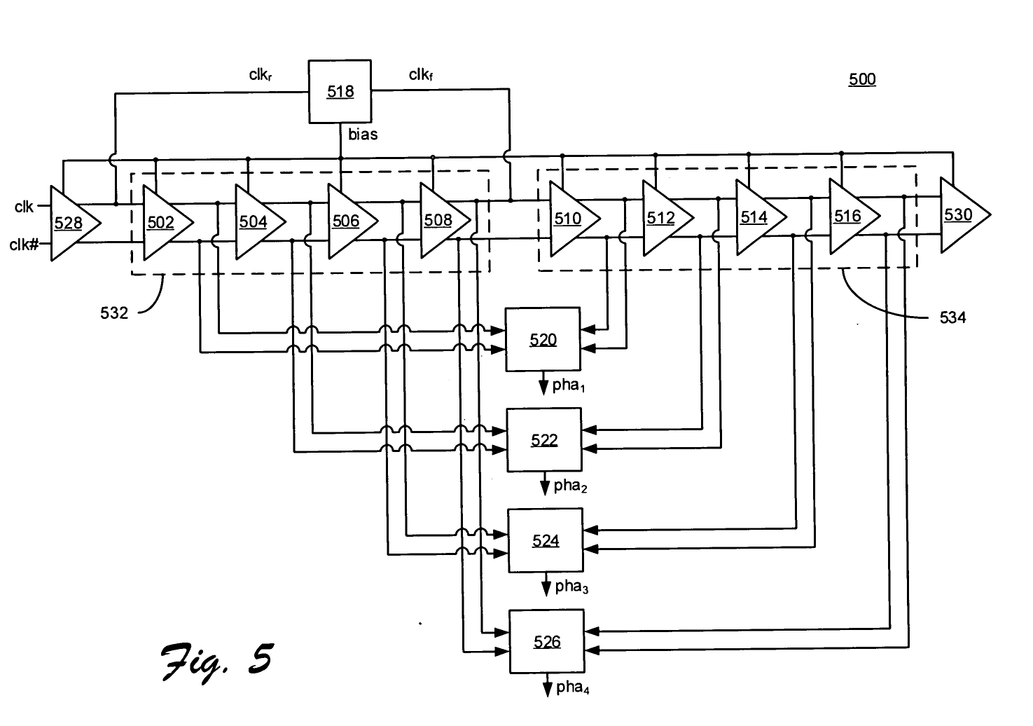

Furthermore, the exemplary embodiment of the DLL with time averaging 200, as described above, is implemented utilizing two separate DLLs. However, those skilled in the art appreciate that the circuitry of a plurality of DLLs, or a PLL and one or more DLLs, may be combined such that they are implemented by a plurality of delay line and common control circuits as described in more detail below with regard to FIG. 5.

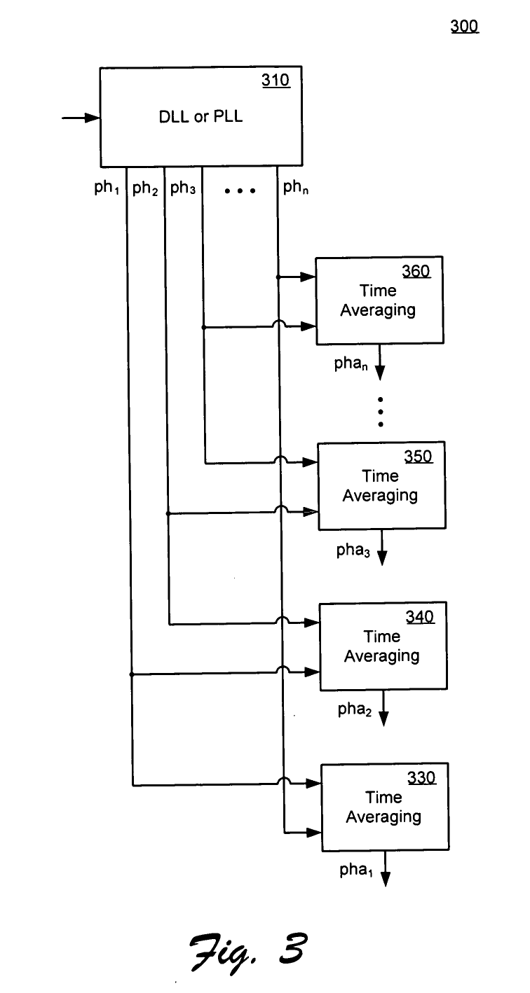

FIG. 3 shows another exemplary embodiment of a clock modulation circuit with time averaging 300. In one embodiment, the clock modulation circuit with time averaging 300 includes a delay locked loop (DLL) 310 and a plurality of time averaging circuits 330-360 coupled to the DLL 310. In another embodiment, the clock modulation circuit with time averaging 300 includes a phase locked loop (PLL) 310 and a plurality of time averaging circuits 330-360 coupled to the PLL 310. Although in the following discussion, the time averaging function is further described with reference to DLLs to explain the operating principles it should be readily apparent that these techniques are equally applicable to PLLs.

The delay locked loop 310 receives an incoming clock signal (clk) at its input and generates a plurality of phase shifted clock signals (ph₁, ph₂, ph₃, . . . phₙ) at its outputs. Adjacent phase shifted clock signals (ph₁, ph₂, ph₃, . . . phₙ) from the DLL 310 are received by a corresponding one of the plurality of time averaging circuits 330-360. For example, the first time averaging circuit 330 receives the first and n^{th} phase shifted clock signals (ph₁, phₙ), while the second time averaging circuit 360 receives the second and first phase shifted clock signals (ph₂, ph₁). The time averaging circuits 330-360 phase mix the respective adjacent phase shifted clock signals (ph₁, ph₂, ph₃, . . . phₙ) to generate corresponding average phase shifted signals (pha₁, pha₂, pha₃, . . . phaₙ) at their respective output. Thus, the time averaging circuits 330-360 average the phase shift between adjacent phase shifted clock signals from the same clock cycle. Averaging the phase shifted clock signals from the same clock cycle reduces inaccuracies in the spacing between the phases.

The exemplary embodiment of the DLL with time averaging 300, as described above, averages sets of two adjacent phase shifted clock signals from the same clock cycle. However, those skilled in the art will appreciate that the above described time averaging function may be adapted to average sets of three or more adjacent phase shifted clock signals from the same clock cycle in both DLLs and PLLs. Time averaging sets of three or more adjacent phase shifted clock signals can be achieved by modifying the number of inputs averaged by the time averaging circuits. An exemplary time averaging circuit adaptable to receive and average any number of inputs as described in more detail below with regard to FIG. 6.

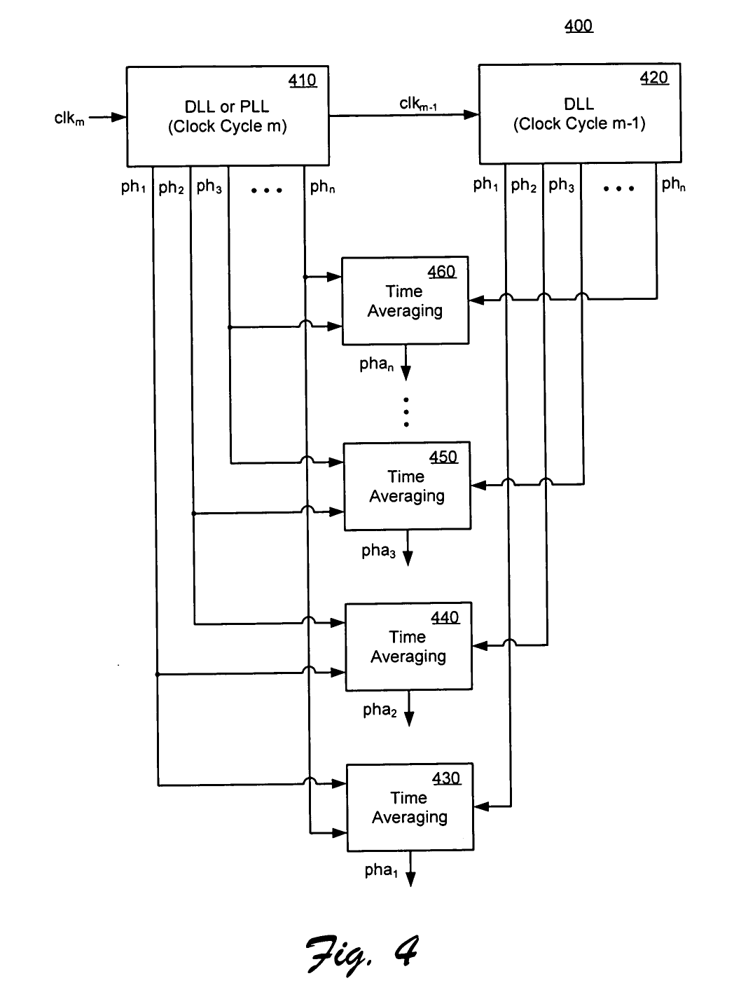

FIG. 4 shows another exemplary embodiment of a clock modulation circuit with time averaging 400. In one embodiment, the clock modulation circuit with time averaging 400 includes a first delay locked loop (DLL) 410, a second DLL 420 coupled in series with the first DLL 410, and a plurality of time averaging circuits 430-460 coupled between the first and second DLLs 410, 420. In another embodiment, the clock modulation circuit with time averaging 400 includes a first phase locked loop (PLL) 410, a first DLL 420 coupled in series with the first PLL 410, and a plurality of time averaging circuits 430-460 coupled between the first PLL 410 and the first DLL 420. Although in the following discussion, the time averaging function is further described with reference to DLLs to explain the operating principles it should be readily apparent that these techniques are equally applicable to PLLs.

The first DLL 410 receives an incoming clock signal (clkₘ) at its input and generates a plurality of phase shifted clock signals (ph₁, ph₂, ph₃, . . . phₙ) at its outputs. The second DLL 420 receives the differential clock signal (clkₘ₋₁) at its input, after propagation through the first DLL 410. The differential clock signal (clkₘ₋₁) received by the second DLL 420 is delayed one full clock cycle as compared to the clock signal (clkₘ) received by the first DLL 410. Thus, the plurality of phase shifted clock signals (ph₁, ph₂, ph₃, . . . phₙ) generated by the second DLL 420 are delayed one clock cycle with respect to the corresponding one of the plurality of phase shifted clock signals (ph₁, ph₂, ph₃, . . . phₙ) generated by the first DLL 410.

The adjacent phase shifted clock signals from the first DLL 410 and a phase shifted clock signal from the second DLL 420 that corresponds to one of the adjacent phase shifted clock signals from the first DLL 410 are received by a corresponding one of the plurality of time averaging circuits 430-460. For example, the first time averaging circuit 430 received the first and nth phase shifted clock signals (ph₁, phₙ) from the first DLL 410 and the first phase shifted clock signal (ph₁) from the second DLL 420. The second time averaging circuit 440 receives the second and first phase shifted clock signals (ph₂, ph₁) from the first DLL 410 and the second phase shifted clock signal (ph₂) from the second DLL 420.

The time averaging circuits 430, 440, 450, 460 phase mix the respective adjacent phase shifted clock signals from the first DLL 420 and the respective phase shifted clock signal from the second DLL 420 that corresponds to one of the adjacent phase shifted clock signals from the first DLL 410. Each time averaging circuit 430-460 generates a corresponding average phase shifted signal (pha₁, pha₂, pha₃, . . . phaₙ) at its respective output. Thus, the time averaging circuits 430-460 average the phase shift between adjacent phase shifted clock signals from the same clock cycle (m) and one of the corresponding phase shifted clock signals from the adjacent clock cycle (m-1). The averaging of the phase shifted clock signals from the same clock cycle and the adjacent clock cycle reduces jitter and spacing inaccuracies on all the clock phases.

The exemplary embodiment of the DLL with time averaging 400, as described above, averages sets of two adjacent phase shifted clock signals from the same clock cycle and one of the corresponding phase shifted clock signal from an adjacent clock cycle. However, those skilled in the art will appreciate that the above described time averaging function may be adapted to average set of three or more adjacent phase shifted clock signals from the same clock cycle and one or more corresponding phase shifted clock signals from adjacent clock cycles in both DLLs and PLLs. Time averaging sets of multiple adjacent phase shifted clock signal in the same cycle with one or more corresponding phase shifted clock signals in adjacent clock cycles can be achieved by adding additional serially coupled DLLs and modifying the number of inputs averaged by the time averaging circuits. An exemplary time averaging circuit adaptable to receive and average any number of inputs is described in more detail below with regard to FIG. 6.

Furthermore, the exemplary embodiment of the DLL with time averaging 400, as described above, is implemented utilizing a plurality of separate DLLs. However, those skilled in the art appreciate that the circuits of a plurality of DLLs, or a PLL and one or more DLLs, may be combined such that they are implemented by a plurality of delay lines and common control circuits as described in more detail below with regard to FIG. 5.

FIG. 5 shows an exemplary embodiment of a delay locked loop with time averaging 500. The delay locked loop with time averaging 500 includes a first plurality of serially coupled inverters 502-508, a second plurality of serially coupled inverters 510-516, control circuits 518 and a plurality of time averaging circuits 520-526. The delay locked loop with time averaging 500 may further include an input inverter 528 and a termination inverter 530 to provide impedance matching at the input of the first plurality of serial coupled inverters 502-508 and the output of the second plurality of serial coupled inverters 510-516, respectively. Each inverter 502-516 implements a voltage controlled differential delay element. Further, the first plurality of serially coupled inverters 502-508 implement a first delay line 532, and the second plurality of serially coupled inverters 510-516 implement a second delay line 534 The number of delay elements here is representative, and not limited to four as depicted in the diagram.

The control circuits 518 may be utilized to bias both the first delay line 532 and the second delay line 534. In addition, those skilled in the art also appreciate that separate control circuits may be implemented to provide the bias voltage for the second delay line 534. The control circuits 518 provides phase and/or frequency detection, charge pump and bias voltage functions. In one embodiment, a phase detector in the control circuit 518 compares the phase difference between a reference clock (clkᵣ) (e.g., input clock) and a feedback clock (clk_{f}). In another embodiment, a frequency detector may be utilized to determine the frequency difference between the reference clock (clkᵣ) and the feedback clock (clk_{f}). In yet another embodiment, a phase-frequency detector may be utilized to determine the phase and frequency difference between the reference clock (clkᵣ) and the feedback clock (clk_{f}). The phase and/or frequency difference is utilized to drive a charge pump.

The bias voltage generated by the charge pump determines the delay through each inverter 502-516. Decreasing or increasing the bias voltage causes the inverts to speed up or slow down, respectively, to achieve a lock state where the phase of the reference clock and feedback clock have a particular phase relationship (e.g., in-phase or 180° out-of-phase). Thus, the delay through each inverter 502-516 is controlled by the bias voltage generated by the control circuits 518.

The corresponding phase shifted clock signals from each of the delay lines 532, 534 are received by a corresponding one of the plurality of time averaging circuits 520-526. For example, the first phase shifted clock signal from the first and fifth differential delay elements 502, 510 are received by the first time averaging circuit 520, while the fourth phase shifted clock signal from the fourth and eighth differential delay elements are received by the fourth time averaging circuit 526. The time averaging circuits 520-526 average the time delay of the corresponding phase shifted clock signals from the first and second delay lines 532, 534. Thus, each time averaging circuit 520-526 generates a corresponding average phase shifted signal (pha₁, pha₂, pha₃, pha₄) at its respective output. Averaging the phase shift between corresponding phase shifted clock signals of adjacent clock cycles reduces jitter received on the clock input (clk, clk#), injected by the power supply, injected from the substrate, generated in the DLL, and the like. A specific implementation may not use or need all of the time averaging circuits, 520-526 and may be implemented with a subset of the time averaging circuits.

Although the above described delay lock loop with time averaging 500 illustrates generation of four time averaged phase shifted clock signals (pha₁, pha₂, pha₃, pha₄), those skilled in the art will appreciate that the circuit may be modified to generate any number of time averaged phase shifted clock signals. Similarly, the illustrated delay locked loop with time averaging 500 may be modified to average corresponding phase shifted clock signals from any number of clock cycles. In addition, the illustrated delay locked loop with time averaging 500 may be modified to implement a PLL in combination with one or more DLLs that generate any number of time averaged phase shifted clock signals as a function of corresponding phase shifted clock signals from any number of clock cycles. For example, in such an embodiment the output of the first delay line 532 may be coupled to the input of the first delay line 532 to form a voltage control oscillator. The delay elements 510, 512, 514, 516 in the second delay line 534 should have twice the delay of the delay elements 502, 504, 506, 508 in the first delay line 532, if the first delay line 532 is configured to act as a voltage controlled oscillator. Accordingly, the circuit includes PLL followed by a DLL, wherein the DLL shared the same biasing conditions as established by the PLL feedback.

Furthermore, the above described delay locked loop with time averaging 500 may be modified, in view of the embodiments illustrated in FIG. 3, to average the phase shift between two or more adjacent phase shifted clock signals from the same clock cycle. Such DLLs and PLLs that average two or more adjacent phase shifted clock signals from the same clock cycle reduce inaccuracies in the spacing between the phases in the received clock input (clk, clk#), injected by the power supply, injected from the substrate, generated in the DLL, and the like. Similarly, the above described delay locked loop with time averaging 500 may be modified, in view of the embodiments illustrated in FIG. 4, to average the phase shift between two or more adjacent phase shifted clock signals from the same clock cycle and one or more of the corresponding phase shifted clock signals from one or more adjacent clock cycles. Such DLLs and PLLs that average two or more adjacent phase shifted clock signals from the same clock cycle with one or more of the corresponding phase shifted clock signals from adjacent clock cycles reduce jitter and spacing inaccuracies on all the clock phases.

Exemplary Time Averaging Circuit

FIG. 6 shows an exemplary embodiment of a time averaging circuit 600. The time averaging circuit 600 includes a plurality input transistor pairs 610-640. The plurality of input transistor pairs 610-640 are coupled to voltage controlled load elements 650-690. In an exemplary embodiment, the voltage controlled load elements 650-690 may be implemented by a set of transistors biased as voltage controlled resistors by control voltages (nbias, pbias). The control voltages may be generated by the same control circuit utilized by the DLL or PLL. Alternatively, a separate control circuit may be implemented to provide the bias voltages for the time averaging circuit.

In one implementation, the plurality of input transistor pairs may include a plurality of source coupled n-type metal-oxide-semiconductor field effect transistors (N-MOSFET). However, those skilled in the art will appreciate that the input transistor pairs may also be implemented by p-type MOSFETs. Similarly, the input transistor pairs may also be implemented by junction field effect transistors (JFET) or bipolar junction transistors (BJT).

Each pair of input transistors 610-640 receives a differential phase shifted clock signal at its input gates (in₁, in#₁, . . . inₙ, in#ₙ). The plurality of input transistor pairs performs time averaging between the phase shifted clock signals to generate differential average phase shifted clock signals at the output (out, out#). For example, a first pair of input transistors 610, 620 may receive a first phase shifted clock signal (ph1, ph#1). A second pair of input transistors 630, 640 may receive a second phase shifted clock signal (ph2, ph#2) from the same clock cycle that is adjacent to the first phase shifted clock signal (ph1, ph#1). The adjacent phase shifted clock signals from the same clock cycle are averaged by the input transistor pairs 610-640 to generate an average phase shifted clock signal at the differential output (out, out#) of the time averaging circuit 600.

In another example, the first pair of input transistors 610, 620 may receive a first phase shifted clock signal (ph1, ph#1). The second pair of input transistors 630, 640 may receive a corresponding first phase shifted clock signal (ph1, ph#1) from an adjacent clock cycle. The corresponding phase shifted signals from the adjacent clock cycles are averaged by the input transistor pairs 610-640 to generate an average phase shifted clock signal at the output (out, out#) of the time averaging circuit 600.

The time averaging circuit is adaptable to receive any number of inputs by adding additional differential input pairs to the plurality of input transistor pairs 610-640. For example, a first pair of the input transistors 610, 620 may receive a first phase shifted clock signal (ph1, ph#1). A second pair of the input transistors 630, 640 may receive a second phase shifted clock signal (ph2, ph#2) from the same clock cycle that is adjacent to the first phase shifted clock signal (ph1, ph#1), and a third pair of the input transistors may receive a corresponding first phase shifted clock signal (ph1, ph#1) from an adjacent clock cycle. The adjacent phase shifted clock signals from the same clock cycle and the corresponding phase shifted clock signal from the adjacent clock cycle are averaged by the input transistor pairs 610-640 to generate an average phase shifted clock signal at the output (out, out#) of the time averaging circuit 600.

In another example, the first pair of input transistors 610, 620 may receive a first phase shifted clock signal (ph1, ph#1) from a first clock cycle. The second pair of input transistors 630, 640 may receive the first phase shifted clock signal (ph1, ph#1) from a second clock cycle, and the third pair of input transistors may receive the first phase shifted clock signal (ph1, ph#1) from a third clock cycle. The corresponding phase shifted clock signal from the adjacent three clock cycles are averaged by the input transistor pairs 610-640 to generate an average phase shifted clock signal at the output (out, out#) of the time averaging circuit 600.

Although various exemplary embodiments of the time averaging circuit 600 have been described, those skilled in the art appreciate that the time averaging circuit 600 may be adapted to average any number of adjacent phase shifted clock signals from the same clock cycle and/or any number of corresponding phase shifted clock signals from any number of adjacent clock cycles by adding additional input transistor pairs. Furthermore, the time averaging circuit 600 may be utilized in both DLLs and PLLs. Thus, averaging may include any suitable averaging technique which may include any suitable biases and is not limited to implementations in the previously described examples.

Exemplary DDL and PLL Time Averaging Method

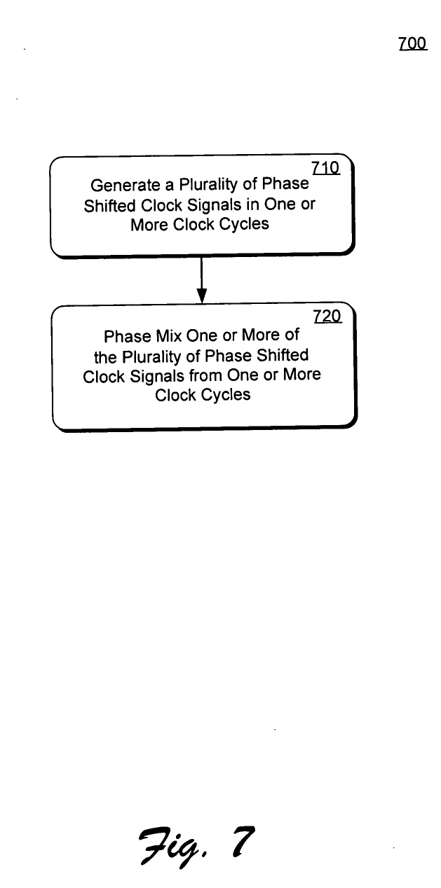

FIG. 7 shows a flow diagram of an exemplary method of modulating a clock signal. The method includes generating a plurality of phase shifted clock signals in each of one or more clock cycles, at 710. In one embodiment, the plurality of phase shifted clock signals are generated by sequentially delaying a received clock signal a plurality of times in one clock cycle. In another embodiment, the plurality of phase shifted clock signals are generated by sequentially delaying a received clock signal a plurality of times in each of a plurality of clock cycles.

At 720, one or more of the plurality of phase shifted clock signals from one or more clock cycles are phase mixed to generate an averaged phase shifted clock signal. In one embodiment, each phase shifted clock signal from one clock cycle is averaged with a corresponding phase shifted clock signal from one or more other adjacent clock cycles. In another embodiment, each set of two or more adjacent phase shifted clock signals from the same clock cycle are averaged. In yet another embodiment, each set of two or more adjacent phase shifted clock signals from the same clock cycle are averaged with a corresponding one of the phase shifted clock signals from an adjacent clock cycle. The resulting time averaged phase shifted clock signals are characterized by reduced jitter and/or and spacing inaccuracies, as compared to the phase shifted clock signals generated at 710.

Conclusion

The above detailed description generally describes embodiments of phase lock loops and/or delay lock loops in combination with embodiments of time averaging techniques. However, those skilled in the art appreciated that the time averaging techniques may be integrated with the delay lock loop and/or phase lock loop as delay lock loops having time averaged outputs and/or phase lock loops with time averaged outputs. Furthermore, techniques for time averaging in combination with phase lock loops and delay lock loops have been described in language specific to structural features and/or methods. However, it is to be understood that the subject of the appended claims is not necessarily limited to the specific features or methods described. Rather, the specific features and methods are disclosed as exemplary implementations of time averaging in clock modulation circuits.

What is claimed is:

1. An apparatus comprising:
one or more delay locked loops, each delay locked loop to generate a plurality of phase shifted clock signals; and
a plurality of time averaging circuits coupled to the one or more delay locked loops, each time averaging circuit to respectively phase mix two or more of the plurality of phase shifted clock signals.

2. An apparatus as recited in claim 1, wherein:
the one or more delay locked loops comprises a first delay locked loop and a second delay locked loop serially coupled to the first delay locked loop;
the first and second delay locked loops are to modulate adjacent clock cycles; and
each time averaging circuit, respectively, is to phase mix corresponding phase shifted clock signals from adjacent clock cycles.

3. An apparatus as recited in claim 1, wherein:
the one or more delay locked loops comprises a first delay locked loop and a second delay locked loop serially coupled to the first delay locked loop;
the first and second delay locked loops are to modulate adjacent clock cycles; and
each time averaging circuit, respectively, is to phase mix a set of adjacent phase shifted clock signals from the same clock cycle and a corresponding one of the phase shifted clock signals from the adjacent clock cycle.

4. An apparatus as recited in claim 1, wherein:
the one or more delay locked loops consists of one delay locked loop; and
each time averaging circuit is to respectively phase mix a set of adjacent phase shifted clock signals from one clock cycle.

5. An apparatus as recited in claim 1, wherein each delay locked loop includes a separate voltage controlled delay line and shares one control circuit that is to generate a biasing voltage for the voltage controlled delay line of each delay locked loop.

6. An apparatus as recited in claim 5, wherein the one control circuit is to further generate the biasing voltage for the plurality of time averaging circuits.

7. An apparatus as recited in claim 1, wherein each voltage controlled delay line comprises a plurality of serial coupled differential delay elements.

8. An apparatus as recited in claim 1, wherein each time averaging circuit comprises:
a plurality of input transistor pairs; and
a voltage controlled load coupled to the plurality of input transistor pairs.

9. An apparatus as recited in claim 8, wherein the number of input transistor pairs corresponds to the number of phase shifted clock signals phase to be mixed by each time averaging circuit.

10. A system comprising:
a wireless input/output device; and
a device communicatively coupled to the wireless input/output device, the device comprising:
one or more serially coupled delay lines, each delay line to generate a plurality of phase shifted clock signals; and
a plurality of time averaging circuits coupled to the one or more delay lines, each time averaging circuit to average a different set of two or more of the phase shifted clock signals.

11. A system as recited in claim 10, wherein:
the one or more delay lines comprises a first delay line and a second delay line; and
each time averaging circuit is to average corresponding phase shifted clock signals from each of the delay lines.

12. A system as recited in claim 10, wherein:
the one or more delay lines comprises a first delay line and a second delay line; and
each time averaging circuit is to average a set of adjacent phase shifted clock signals from the first delay line and a corresponding one of the phase shifted clock signals from the second delay line.

13. A system as recited in claim 10, wherein:
the one or more delay lines consists of one delay line; and
each time averaging circuit is to average a different set of adjacent phase shifted clock signals from the one delay line.

14. A system as recited in claim 10, wherein each delay line comprises a plurality of differential delay elements.

15. A system as recited in claim 10, wherein each differential delay element is to introduce a substantially fixed amount of delay to a clock signal.

16. A system as recited in claim 10, wherein each time averaging circuit comprises:
a plurality of input transistor pairs; and
a voltage controlled load coupled to the plurality of input transistor pairs.

17. An apparatus comprising:
a phase locked loop to generate a plurality of phase shifted clock signals; and
a plurality of time averaging circuits coupled to the phase locked loop, each time averaging circuit is to respectively phase mix two or more phase shifted clock signals.

18. An apparatus as recited in claim 17, further comprising:
a delayed locked loop serially coupled to the phase lock loop;
wherein the phase locked loop and the delayed locked loop are to modulate adjacent clock cycles; and
wherein each time averaging circuit is to phase mix different sets of corresponding phase shifted clock signals from adjacent clock cycles.

19. An apparatus as recited in claim 17, further comprising:
a delay locked loop serially coupled to the phase lock loop;
wherein the phase locked loop and delay locked loop are to modulate adjacent clock cycles; and
wherein each time averaging circuit is to phase mix a different set of adjacent phase shifted clock signals from the same clock cycle and a corresponding one of the phase shifted clock signals from the adjacent clock cycle.

20. An apparatus as recited in claim 17, wherein each time averaging circuit is to phase mix a different set of adjacent phase shifted clock signals from one clock cycle.

21. An apparatus as recited in claim 17, wherein:
the phase locked loop comprises a plurality of serially coupled differential delay elements: and
each time averaging circuit comprises a plurality of input transistor pairs coupled to a voltage controlled load.

22. An apparatus as recited in claim 21, wherein the number of input transistor pairs corresponds to the number of differential delay elements.

23. A method comprising:
generating a plurality of phase shifted clock signals in one or more clock cycles; and
phase mixing two or more of the plurality of phase shifted clock signals.

24. A method as recited in claim 23, wherein generating the plurality of phase shifted clock signals comprises sequentially delaying a received clock signal a plurality of times in one clock cycle.

25. A method as recited in claim 24, wherein phase mixing two or more of the plurality of phase shifted clock signals comprises averaging each set of two or more adjacent phase shifted clock signals.

26. A method as recited in claim 23, wherein generating a plurality of phase shifted clock signals comprises sequentially delaying a received clock signal a plurality of times in each of a plurality of clock cycles.

27. A method as recited in claim 26, wherein phase mixing two or more of the plurality of phase shifted clock signals comprises averaging each corresponding one of the plurality of phase shifted clock signals in two or more adjacent clock cycles.

28. A method as recited in claim 26, wherein phase mixing two or more of the plurality of phase shifted clock signals comprises averaging each set of two or more adjacent phase shifted clock signals from a given clock cycle and a corresponding one of the plurality of phase shifted clock signals in an adjacent clock cycle.

29. A method as recited in claim 26, wherein phase mixing two or more of the plurality of phase shifted clock signals comprises averaging each set of two or more adjacent phase shifted clock signals from a given clock cycle and a corresponding one of the plurality of phase shifted clock signals in each of a plurality of adjacent clock cycles.
